(19) United States
(12) Patent Application Publication
(10) Pub. No.: US 2023/0106448 A1
(43) Pub. Date: Apr. 6, 2023

(54) DIVERSIFYING RECOMMENDATIONS BY IMPROVING EMBEDDING GENERATION OF A GRAPH NEURAL NETWORK MODEL

(71) Applicant: Lemon Inc., Grand Cayman (KY)

(72) Inventors: Liangwei YANG, Los Angeles, CA (US); Shengjie WANG, Los Angeles, CA (US); Yunzhe TAO, Los Angeles, CA (US); Jiankai SUN, Los Angeles, CA (US); Taiqing WANG, Los Angeles, CA (US)

(21) Appl. No.: 17/985,788

(22) Filed: Nov. 11, 2022

(51) Int. Cl. G06N 3/04; G06N 3/08

(52) U.S. Cl. CPC G06N 3/04; G06N 3/08

(57) ABSTRACT

The present disclosure describes techniques for diversifying recommendations by improving embedding generation of a Graph Neural Network (GNN) model. A subset of neighbors for each GNN item node may be selected on an embedding space for aggregation. The subset of neighbors may comprise diverse items and may represent an entire set of neighbors of the GNN item node. Attention weights may be assigned for a plurality of layers of the GNN model to mitigate over-smoothing of the GNN model. Loss reweighting may be performed by adjusting weight for each sample item during training the GNN model based on a category of the sample item to focus on learning of long-tail categories.

### BACKGROUND

Machine learning models are increasingly being used across a variety of industries to perform a variety of different tasks. Such tasks may include making predictions or recommendations about data. Improved techniques for utilizing machine learning models are desirable.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 shows an example system that may be used in accordance with the present disclosure.

FIG. 2 shows an example framework for sub-modular neighbor selection in accordance with the present disclosure.

FIG. 3 shows an example framework for layer attention in accordance with the present disclosure.

FIG. 4 shows an example framework for loss reweighting in accordance with the present disclosure.

FIG. 5 shows an example graph illustrating long-tail categories in accordance with the present disclosure.

FIG. 6 shows an example process for improving embedding generation of a graph neural network model in accordance with the present disclosure.

FIG. 7 shows an example process for improving embedding generation of a graph neural network model in accordance with the present disclosure.

FIG. 8 shows an example process for improving embedding generation of a graph neural network model in accordance with the present disclosure.

FIG. 9 shows an example process for improving embedding generation of a graph neural network model in accordance with the present disclosure.

FIG. 10 shows an example process for improving embedding generation of a graph neural network model in accordance with the present disclosure.

FIG. 11 shows a graph illustrating experimental results associated with a recommender system in accordance with the present disclosure.

FIG. 12 shows a set of tables illustrating experimental results associated with a recommender system in accordance with the present disclosure.

FIG. 13 shows a set of graphs illustrating experimental results associated with a recommender system in accordance with the present disclosure.

FIG. 14 shows a graph illustrating experimental results associated with a recommender system in accordance with the present disclosure.

FIG. 15 shows a set of graphs illustrating experimental results associated with a recommender system in accordance with the present disclosure

FIG. 16 shows a table illustrating experimental results associated with a recommender system in accordance with the present disclosure.

FIG. 17 shows a set of charts illustrating experimental results associated with a recommender system in accordance with the present disclosure

FIG. 18 shows an example computing device which may be used to perform any of the techniques disclosed herein.

### DETAILED DESCRIPTION OF ILLUSTRATIVE EMBODIMENTS

Nowadays, new data is continuously being created. The amount of data being created is too large to efficiently digest. Recommender systems aim to mitigate this problem by providing people with the most relevant information from the massive amount of data. Such recommender systems play an essential role in daily life. For example, such recommender systems may be utilized to recommend relevant content to be displayed in a person's news feed, relevant music suggestions for a person, relevant shopping recommendations for a person, and/or the like. Accuracy is often a criterion that is utilized to measure how likely a person is to interact with the items recommended for them by a recommender system. Thus, companies and researchers have developed techniques to optimize accuracy during all steps in recommender systems (e.g., retrieval and/or re-ranking).

A well-designed recommender system should be evaluated from multiple perspectives—not just from an accuracy perspective. For example, a well-designed recommender system should be evaluated from both an accuracy and a diversity perspective. As accuracy can only reflect correctness, pure accuracy-targeted methods may lead to undesirable echo chamber or filter bubble effects and/or may trap users in a small subset of familiar items without exploring the vast majority of other items. Achieving diversity in a recommender system may break the filter bubble. Diversified recommendation targets may increase the dissimilarity among recommended items to capture users' varied interests. However, optimizing diversity in a recommender system may cause a decrease in the accuracy of the recommender system. Thus, techniques for increasing the diversity of a recommender system while minimizing any decrease in the accuracy of the recommender system are desirable.

Graph-based recommender systems are associated with several advantages when compared to traditional non-graph-based recommender systems. Users' historical interactions may be represented as a user-item bipartite graph. Representing users' historical interactions as a user-item bipartite graph may provide easy access to high-order connectivities. A graph neural network (GNN) is a family of powerful learning methods for graph-structured data. Graph-based recommender systems may be configured to design suitable GNNs to aggregate information from the neighborhood of every node of the graph-structured data to generate a node embedding. This procedure may provide opportunities for diversified recommendations. First, the user/item embedding is easily affected by its neighbors, and we can manipulate the choice of neighbors to obtain a more diversified embedding representation. Second, the unique high-order neighbors of each user/item node can provide us with personalized distant interests for diversification, which can be naturally captured by stacking multiple GNN layers.

However, such an aggregation procedure often accumulates information purely based on the graph structure, overlooking the redundancy of the aggregated neighbors and resulting in poor diversity of the recommended list. First, it is difficult to effectively manipulate the neighborhood to increase diversity. The popular items may submerge the long-tail items if a direct aggregation is performed on all neighbors. Second, an over-smoothing problem may occur when directly stacking multiple GNN layers. Over-smoothing may lead to similar representations among nodes in the graph, dramatically decreasing accuracy. Third, the item occurrence in data and the number of items within each category both follow the power-law distribution. Training a GNN under the power-law distribution may cause the GNN to focus on popular items/categories, which only constitute a small part of the items/categories. Meanwhile, long-tail items/categories may be imperceptible during the training stage. Thus, techniques for improving embedding generation of a GNN model are needed.

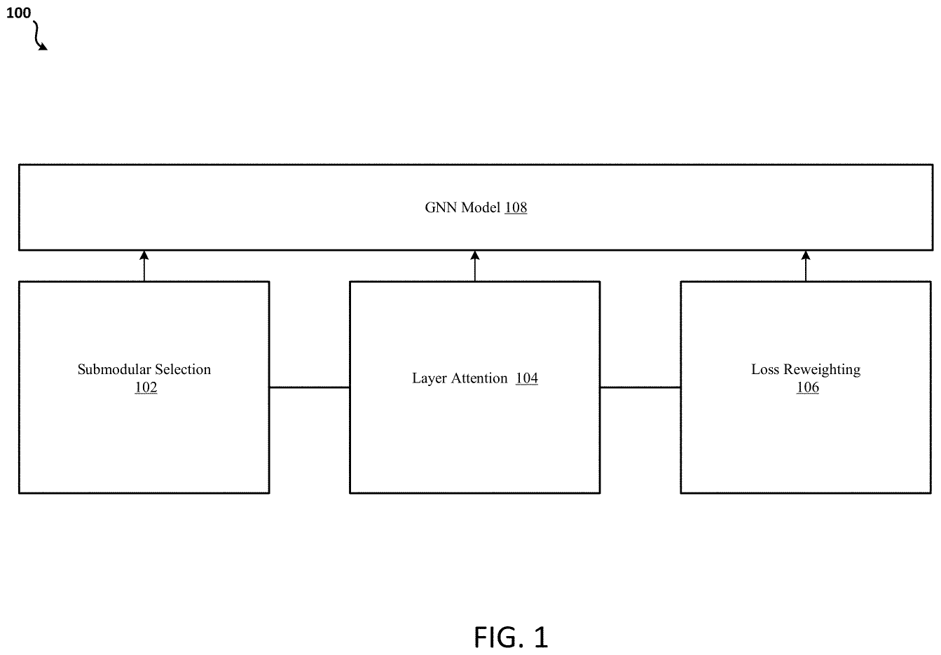

Described here are techniques for diversifying GNN based recommender systems by directly improving the embedding generation procedure. FIG. 1 illustrates an example recommender system 100 that may be used in accordance with the present disclosure. The recommender system 100 may generate diversified recommendations while maintaining recommendation accuracy using a GNN model with improved embedding generation. The system 100 comprise a GNN model 108 as well as a sub-modular selection module 102, a layer attention module 104, and a loss reweighting module 106. The sub-modular selection module 102 may integrate submodular optimization into the GNN model 108. The sub-modular selection module 102 may be configured to determine (e.g., identify, find, select) a subset of diverse neighbors to aggregate for each GNN node. The sub-modular selection module 102 may be configured to determine the diversified subset of neighbors by optimizing a submodular function. Information aggregated from the diversified subset may help to uncover long-tail items and reflect them in the aggregated representation.

The layer attention module 104 may be configured to mitigate or eliminate the over-smoothing problem. The layer attention module 104 may be configured to stabilize the training on deep GNN layers and may enable the system 100 to take advantage of high-order connectivities for diversification. To stabilize the training on deep GNN layers and/or enable the system 100 to take advantage of high order connectivities for diversification, the layer attention module 104 may be configured to assign attention weights for each layer of the GNN model.

The loss reweighting module 106 may be configured to reduce the weight given to popular items or categories. The loss reweighting module 106 may be configured to focus on the learning of items belonging to long-tail (e.g., less popular) items or categories. By focusing on the learning of items belonging to long-tail (e.g., less popular) items or categories, the loss reweighting module 106 may assist the GNN model 108 in focusing more on the long-tail items or categories and less on the popular items or categories.

Blending the sub-modular selection module 102, the layer attention module 104, and the loss reweighting module 106 into the GNN model 108 may lead to diversified recommendation while keeping the accuracy comparable to state-of-the-art GNN-based recommender systems. For a diversified recommendation task, a set of users U may be represented as {u₁, u₂, . . . , u_{|U|}}, a set of items I may be represented as {i1, i₂, . . . , i_{|I|}}, and a mapping function C(·) may be configured to map each item to its category. The observed user-item interactions may be represented as an interaction matrix R∈ [symbol] ^{|U|×|I|}, where R_{u,i}=1 if user u has interacted with item i and R_{u,i}=0 if user u has not interacted with item i. For a graph based recommender model, the historical interactions may be represented by a user-item bipartite graph G=(V, E), where V=U∪I and there is an edge e_{u,i}∈E between u and i if R_{u,i}=1. Learning from the user-item bipartite graph G, the system 100 may be configured to recommend top k interested items {i₁, i₂, . . . , iₖ} for each user u. The top k recommended items may be dissimilar to each other. The dissimilarity (or diversity) of the top k recommended items may be measured by a coverage of recommended categories |∪_{i∈{i}_{_{1, . . . ,}} _{ik}}C(i)|.

The GNN model 108 may be a deep learning model that operates on graph structures. The GNN model 108 may learn the representations of node embeddings by aggregating information from neighbor nodes. Thus, connected nodes in the graph structure may tend to have similar embeddings. The operation of a general GNN computation associated with the GNN model 108 may be expressed as follows:

eᵤ^{(l+1})=eᵤ^{l}⊕AGG^{(l+1)}({eᵢ^{(l)}|i∈Nᵤ}), Equation 1

where eᵤ^{l} indicates node u's embedding on the l-th layer, Nᵤ is the neighbor set of node u, AGG^{(l)}(·) is a function that aggregates neighbors' embeddings into a single vector for layer l, and ⊕ combines u's embeddings with its neighbor's information. AGG(·) and ⊕ may comprise simple functions (e.g., max pooling, weighted sum, etc.) and/or more complicated operations (e.g., attention mechanisms, deep neural networks, etc.) Different combinations of the two operators may constitute different GNN layers (e.g., GCN, GAT, and/or GIN).

In embodiments, a submodular function is a set function defined on a ground set V of elements: ƒ: 2^{V}→ [symbol] . A key defining property of submodular functions is the diminishing-returns property. The diminishing-returns property may be expressed as follows:

ƒ(v|A)≥ƒ(v|B)∀A⊂B⊂V, v∈V and v∉B Equation 2

A shorthand notation ƒ(v|A) :=ƒ({v}∪A)−ƒ(A) may be utilized to represent the gain of an element v conditioned on the set A. The diminishing-returns property naturally describes the diversity of a set of elements. Submodular functions may be applied to various diversity-related machine learning tasks with great success, such as text summarization, sensor placement, and/or training data selection. Submodular functions may also be applied to diversify recommendation systems. However, submodular functions have typically been utilized as a re-ranking method that is orthogonal to the relevance prediction model. Submodular functions may exhibit nice theoretical properties so that optimization of submodular functions can be solved with strong approximation guarantees using efficient algorithms.

Based on the user-item bipartite graph G, the GNN-based recommender system 100 may generate user/item embeddings by GNNs and/or may predict user's preference(s) based on the learned embedding(s). Similar to the learning representation of words and phrases, the embedding technique is also widely used in recommender systems: an embedding layer may comprise a look-up table that maps the user/item ID to a dense vector. The dense vector may be expressed as follows:

E⁽⁰⁾=(e₁⁽⁰⁾,e₂⁽⁰⁾, . . . ,e_{|U|+|I|}⁽⁰⁾, Equation 3

where e⁽⁰⁾∈ [symbol] ^{d} is the d-dimensional dense vector for user/item. An embedding indexed from the embedding table may then be fed into a GNN for information aggregation. Thus, it is noted as the “zero”-th layer output eᵢ⁽⁰⁾.

In embodiments, the light graph convolution (LGC) may be utilized as the backbone GNN layer. The LGC abandons the feature transformation and nonlinear activation, and directly aggregates neighbors' embeddings. The LGC may be expressed as follows:

$${e}_{u}^{( l + 1 )} = {\sum }_{i ∈ {N}_{u}} \frac{1}{\sqrt{\vert {N}_{u} \vert} \sqrt{\vert {N}_{i} \vert}} {e}_{i}^{( l )} , \qquad Equation 4$$

$${e}_{i}^{( l + 1 )} = {\sum }_{u ∈ {N}_{i}} \frac{1}{\sqrt{\vert {N}_{i} \vert} \sqrt{\vert {N}_{u} \vert}} {e}_{u}^{( l )} ,$$

where eᵤ^{(l)} and eᵢ^{(l)} are user u's and item i's embedding at the l-th layer, respectively.

$$\frac{1}{\sqrt{\vert {N}_{u} \vert} \sqrt{\vert {N}_{i} \vert}}$$

is the normalization term following GCN. Nᵤ is u's neighborhood that is selected by a submodular function, as described in more detail below. Each LGC layer may generate one embedding vector for each user/item node. Embeddings generated from different layers may be from the different receptive field. The final user/item representation may be obtained by layer attention module 104, where:

eᵤ=Layer_Attention(eᵤ⁽⁰⁾,eᵤ⁽¹⁾, . . . ,eᵤ^{(layer num)}),

eᵢ=Layer_{Attention(e}_{ᵢ}_{⁽⁰⁾}_{,e}_{ᵢ}_{⁽¹⁾}_{, . . . ,e}_{ᵢ}_{^{(layer num)}}₎. Equation 5

In embodiments, after eᵤ and eᵢ are obtained, the score of u and i pair may calculated by dot product of the two vectors. For each positive pair (u, i), a negative item j may be randomly sampled to compute a Bayesian personalized ranking (BPR) loss. To increase recommendation diversity, the loss may be reweighted to focus more on the long-tail categories:

L=Σ_{(u,i)∈E}w_{C(i)}L_{bpr}(u,i,j)+λ∥Θ∥₂², Equation 6

where w_{C(i)} is the weight for each sample based on its category and λ is the regularization factor.

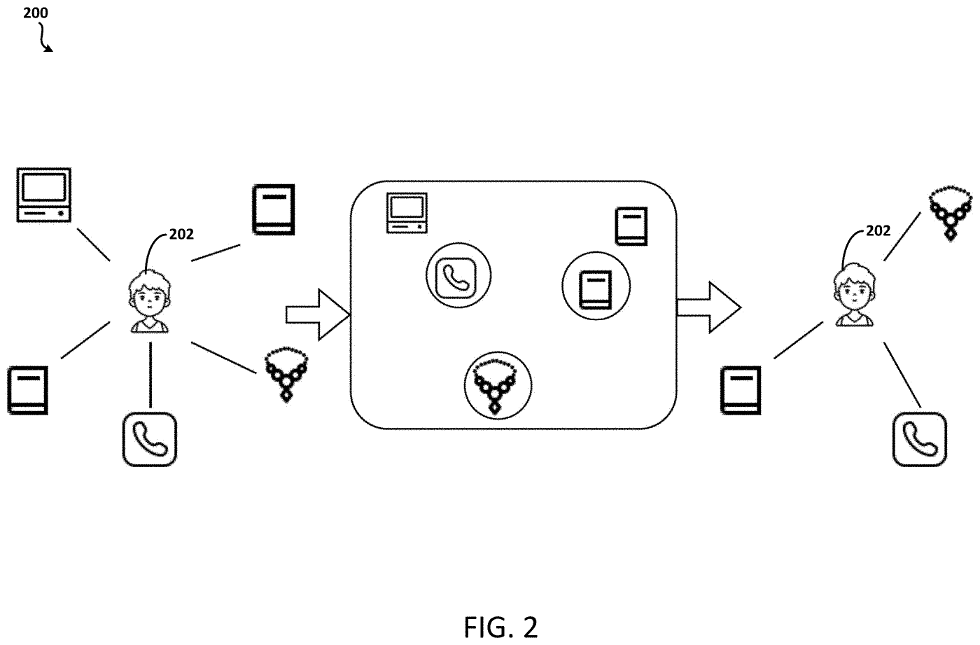

FIG. 2 shows an example framework 200 for sub-modular neighbor selection. In GNN-based recommender systems, user/item embedding may be obtained by aggregating information from all neighbors. Popular items may overwhelm the long-tail items. In the example of FIG. 2, the embedding associated with a user 202 would be much more similar to books if we aggregate all the neighbors. The necklace information may be overwhelmed in the representation associated with the user 202. The sub-modular selection module 102 may select a set of diverse neighbors for aggregation.

In the exemplary GNN neighbor selection described here, the ground set for a user node u consists of all of its neighbors Nᵤ. Facility location function (e.g., Equation 7 below) is a widely used submodular function that evaluates the diversity of a subset of items by first identifying the most similar item in the selected subset Sᵤ to every item i in the ground set (max_{i′∈S}_{ᵤ}sim(i, i′)∀i∈Nᵤ\Sᵤ) and then summing over the similarity values. A subset with a high function value may indicate that for every item in the ground set, there exists a similar item in the selected subset. For example, a subset with a high function value may indicate the selected subset is very diverse and representative of the ground set. The facility location function may be defined as follows:

$$f ( {S}_{u} ) = {\sum }_{i ∈ {N}_{u} ∖ {S}_{u}} {max}_{{i}^{′} ∈ {N}_{u} ∖ {S}_{u}} sim ( i , {i}^{′} ) \qquad Equation 7$$

where Sᵤ is the selected neighbor subset of user u, and sim (i, i′) is the similarity between item i and item i′. sim (i, i′) may be measured by Gaussian kernel parameterized by a kernel width σ²:

$$sim ( i , {i}^{′} ) = exp ( - \frac{{‖ {e}_{i} - {e}_{{i}^{′}} ‖}^{2}}{{σ}^{2}} ) . \qquad Equation 8$$

Sᵤ may be constrained to having no greater than k items for some constant k, i.e., |Sᵤ|≤k. Maximizing the submodular function (e.g., Equation 7) under cardinality constraint is NP-hard, but it may be approximately solved with 1−e⁻¹ bound by the greedy algorithm. The greedy algorithm may start with an empty set Sᵤ:=∅, and adds one item i∈I\Sᵤ with the largest marginal gain to Sᵤ every step:

$${S}_{u} ← {S}_{u} ⋃ {i}^{*} , \qquad Equation 9$$

$${i}^{*} = {arg max}_{i ∈ {N}_{u} \backslash {S}_{u}} [ f ( {S}_{u} ⋃ i ) - f ( {S}_{u} ) ]$$

After k steps of greedy neighbor selection, the diversified neighborhood subset of each user may be obtained. The subset may then be used for aggregation. The above-described framework works for any choice of a submodular function, including but not limited to the facility location function (e.g., Equation 7).

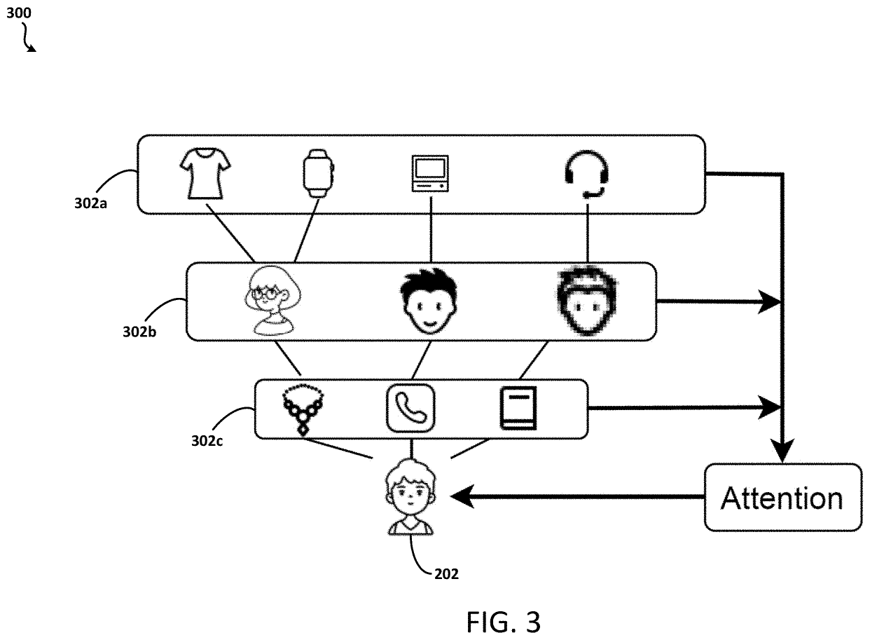

FIG. 3 shows an example framework 300 for layer attention. The framework 300 comprises a plurality of different GNN layers 302a-c. The GNN layers 302a-c may generate embeddings based on information from different subsets of nodes: the l-th layer may aggregate from the l-th hop neighbors. A diversified embedding may be reached by aggregating from the high-order neighbors. However, the direct stack of the GNN layers 302a-c may cause the over-smoothing problem. As shown in the example of FIG. 2, the layer attention module 104 may increase diversity by high-order neighbors and mitigate the over-smoothing problem at the same time.

For each user/item, L embeddings may be generated by L GNN layers. The layer attention module 104 may generate the final representation by learning a Readout function on [e⁽⁰⁾, e⁽¹⁾, . . . , e^{(L)}] by an attention mechanism defined as follows:

e=Readout([e⁽⁰⁾,e⁽¹⁾, . . . ,e^{(L)}])=Σₗ₌₀^{L}a^{(l)}e^{(l)} Equation 10

where a^{(l)} is the attention weight for l-th layer. It may be calculated as:

$${a}^{( l )} = \frac{exp ( 〈 {W}_{Att} , {e}^{( l )} 〉 )}{{\sum }_{{l}^{′ = 0}}^{L} ( 〈 {W}_{Att} , {e}^{( {l}^{′} )} 〉 )} \qquad Equation 11$$

where W_{Att}∈ [symbol] ^{d} is the parameter for attention computation. The attention mechanism may learn different weights for GNN layers 302a-c to optimize the loss function. Optimizing the loss function may effectively alleviate the over smoothing problem.

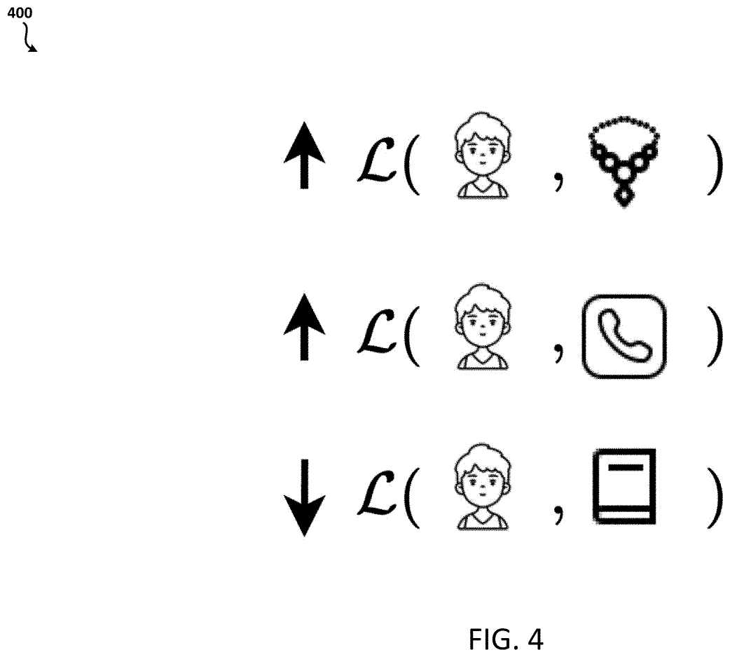

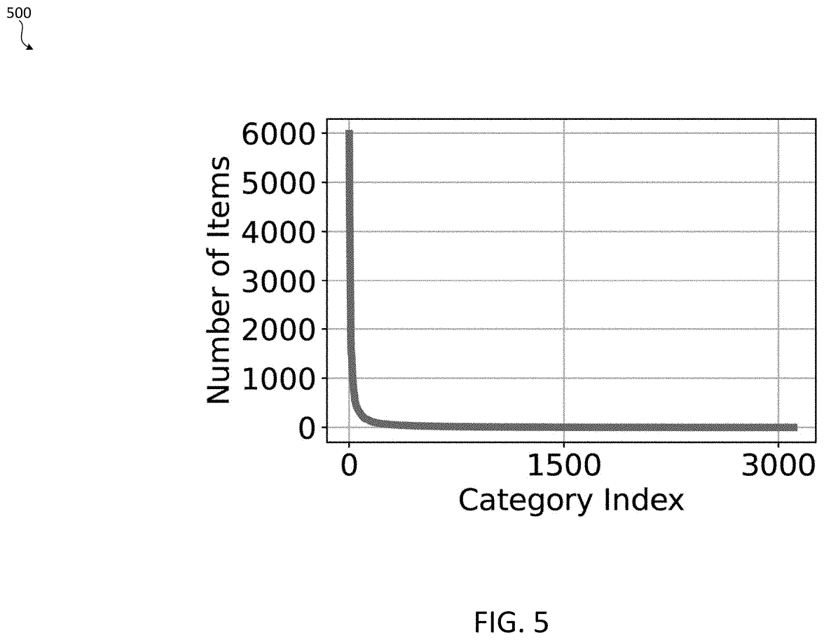

FIG. 4 shows an example framework 400 for loss reweighting. The loss reweighting module 106 may be configured to train the GNN model 108 by directly optimizing the mean loss over all samples. However, directly optimizing the mean loss over all samples may leave the training of long-tail categories imperceptible. However, as shown in the graph 500 of FIG. 5, the number of items within each category is highly imbalanced and follows the power-law distribution. A small number of categories contains the most items while leaving the large majority of categories with only a limited number of items.

To ensure that the training of long-tail categories is not imperceptible, the sample loss may be reweighted during training based on category. As shown in the example of FIG. 4, the weight for a sample may be decreased relatively if the item belongs to a popular category. Conversely, the weight may be increased relatively if the item belongs to a long-tail category. The idea of class-balanced loss may be utilized to reweight the sample (u, i) based on the category effective number of items. The weights w_{C(i)} in Equation 6 may be calculated by:

$${w}_{C ( i )} = \frac{1 - β}{1 - {β}^{\vert C ( i ) \vert}} ,$$

where β is the hyper-parameter that decides the weight. A larger β may further decrease the weight of popular categories.

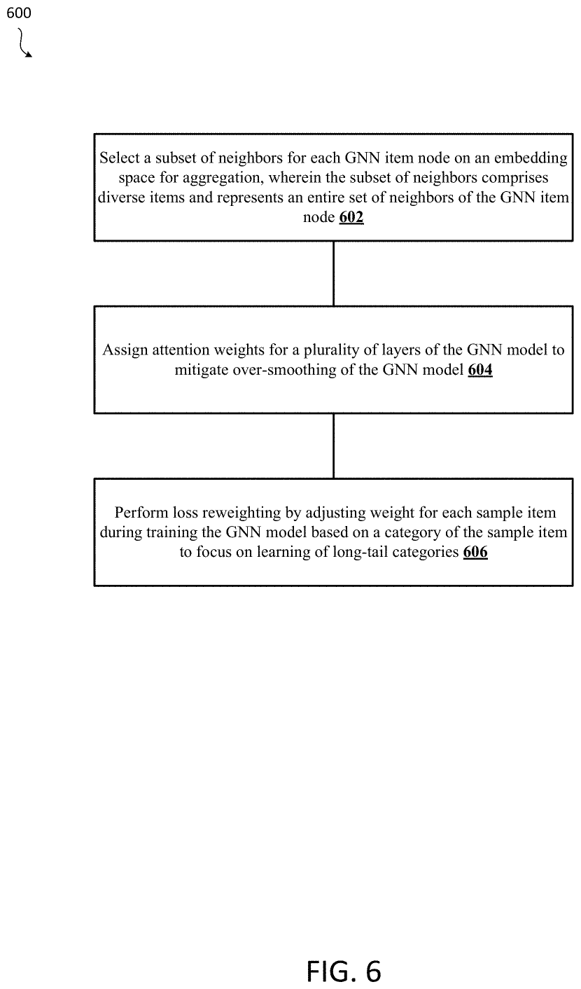

FIG. 6 illustrates an example process 600 of improving embedding generation of a GNN model. For example, the system 100 may perform the process 600. Although depicted as a sequence of operations in FIG. 6, those of ordinary skill in the art will appreciate that various embodiments may add, remove, reorder, or modify the depicted operations.

A sub-modular selection module (e.g., sub-modular selection module 102) may integrate submodular optimization into a GNN model (e.g., GNN model 108). The sub-modular selection module may be configured to determine (e.g., identify, find, select) a subset of diverse neighbors to aggregate for each GNN node. At 602, a subset of neighbors may be selected for each GNN item node on an embedding space for aggregation. For example, the sub-modular selection module may select a set of diverse neighbors for aggregation. The diversified subset of neighbors may be determined, for example, by optimizing a submodular function. The subset of neighbors may comprise diverse items and may represent an entire set of neighbors of the GNN item node. Information aggregated from the diversified subset may help to uncover long-tail items and reflect them in the aggregated representation.

A layer attention module (e.g., layer attention module 104) may be configured to mitigate or eliminate the over-smoothing problem. The layer attention module may be configured to stabilize the training on deep GNN layers and may enable the recommender system to take advantage of high order connectivities for diversification. To stabilize the training on deep GNN layers and/or enable the system to take advantage of high order connectivities for diversification, the layer attention module may be configured to assign attention weights for each layer of the GNN model. At 604, attention weights may be assigned for a plurality of layers of the GNN model. Assigning attention weights for the plurality of layers may mitigate over-smoothing of the GNN model.

A loss reweighting module (e.g., loss reweighting module 106) may be configured to reduces the weight given to popular items or categories. The loss reweighting module may be configured to focus on the learning of items belonging to long-tail (e.g., less popular) items or categories. At 606, loss reweighting may be performed. Loss reweighting may be performed by adjusting weight for each sample item during training the GNN model. The weight for each sample may be adjusted based on a category of the sample item to focus on learning of long-tail categories. By focusing on the learning of items belonging to long-tail (e.g., less popular) items or categories, the loss reweighting module may assist the GNN model in focusing more on the long-tail items or categories and less on the popular items or categories.

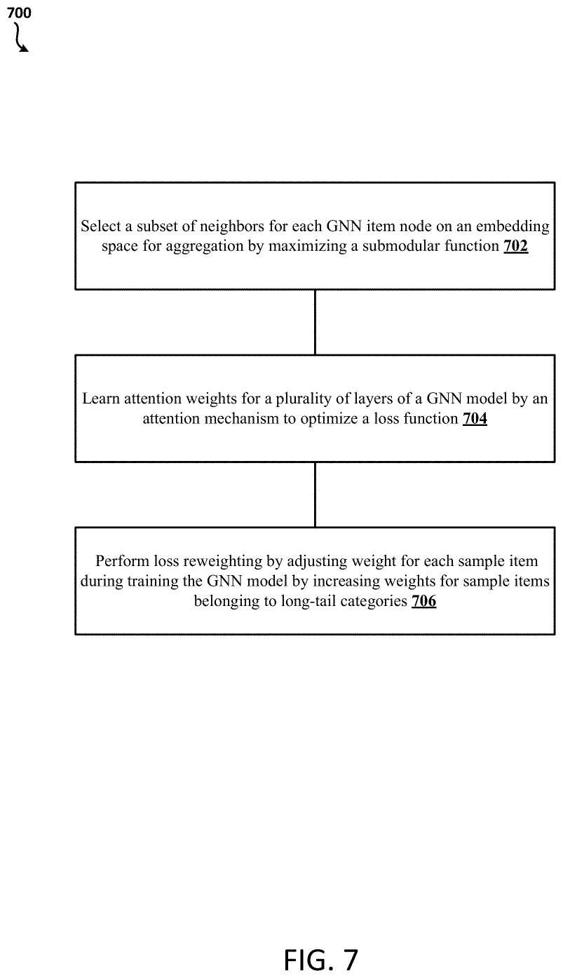

FIG. 7 illustrates an example process 700 of improving embedding generation of a GNN model. For example, the system 100 may perform the process 700. Although depicted as a sequence of operations in FIG. 7, those of ordinary skill in the art will appreciate that various embodiments may add, remove, reorder, or modify the depicted operations.

A sub-modular selection module (e.g., sub-modular selection module 102) may integrate submodular optimization into a GNN model (e.g., GNN model 108). The sub-modular selection module may be configured to determine (e.g., identify, find, select) a subset of diverse neighbors to aggregate for each GNN node. At 702, a subset of neighbors may be selected for each GNN item node on an embedding space for aggregation. The subset of neighbors may be selected by maximizing a submodular function (e.g., Equation 7). The subset of neighbors may comprise diverse items and may represent an entire set of neighbors of the GNN item node. Information aggregated from the diversified subset may help to uncover long-tail items and reflect them in the aggregated representation.

A layer attention module (e.g., layer attention module 104) may be configured to mitigate or eliminate the over-smoothing problem. The layer attention module may be configured to stabilize the training on deep GNN layers and may enable the recommender system to take advantage of high order connectivities for diversification. To stabilize the training on deep GNN layers and/or enable the system to take advantage of high order connectivities for diversification, the layer attention module may be configured to assign attention weights for each layer of the GNN model. At 704, attention weights may be learned for a plurality of layers of the GNN model. The attention weights may be learned by an attention mechanism to optimize a loss function. The learned attention weights may be assigning to the respective layers may mitigate over-smoothing of the GNN model.

A loss reweighting module (e.g., loss reweighting module 106) may be configured to train the GNN model 108 by directly optimizing the mean loss over all samples. To ensure that the training of long-tail categories is not imperceptible, the sample loss may be reweighted during training based on category. At 706, loss reweighting may be performed. Loss reweighting may be performed by adjusting weight for each sample item during training the GNN model. The weight for each sample item may be adjusted by increasing weights for sample items belonging to long-tail categories.

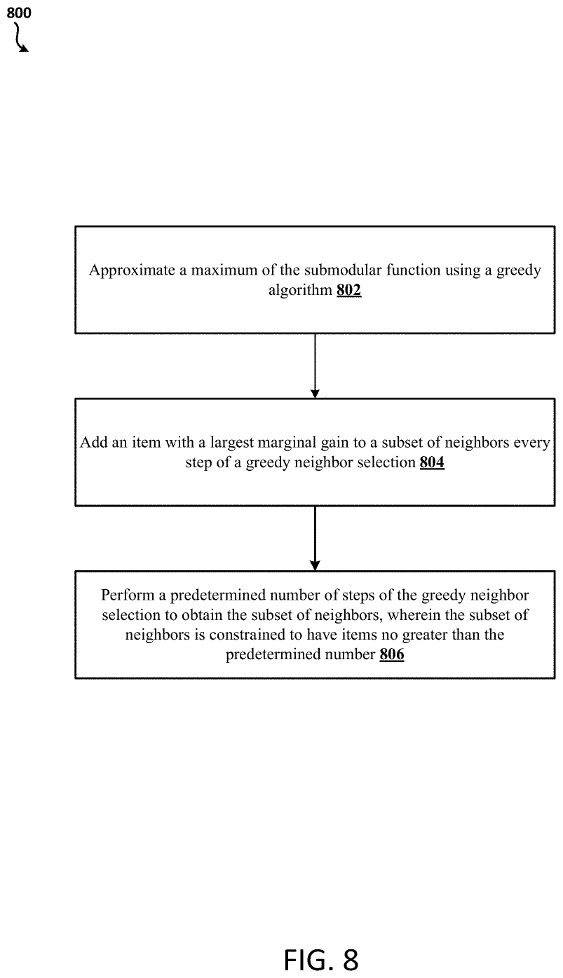

FIG. 8 illustrates an example process 800 of improving embedding generation of a GNN model. For example, the system 100 may perform the process 800. Although depicted as a sequence of operations in FIG. 8, those of ordinary skill in the art will appreciate that various embodiments may add, remove, reorder, or modify the depicted operations.

At 802, a maximum of the submodular function may be approximated. Maximizing the submodular function (e.g., Equation 7) under cardinality constraint is NP-hard, but it may be approximately solved with 1−e⁻¹ bound by a greedy algorithm. The maximum of the submodular function may be approximated using a greedy algorithm. As shown in Equation 9 above, the greedy algorithm may start with an empty set Sᵤ:=∅ and may add one item i∈I\Sᵤ with the largest marginal gain to Sᵤ every step.

At 804, an item with a largest marginal gain may be added to a subset of neighbors every step of a greedy neighbor selection. After k steps of greedy neighbor selection, the diversified neighborhood subset of each user may be obtained. At 806, a predetermined number of steps of the greedy neighbor selection may be performed. The predetermined number of steps may be performed to obtain the subset of neighbors. The subset of neighbors may be constrained to have items no greater than the predetermined number.

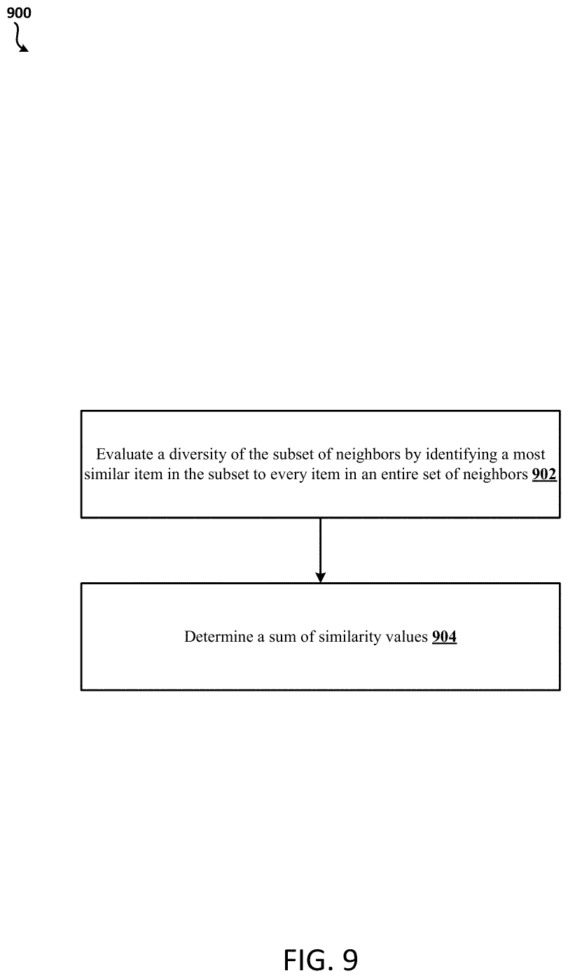

FIG. 9 illustrates an example process 900 of improving embedding generation of a GNN model. For example, the system 100 may perform the process 900. Although depicted as a sequence of operations in FIG. 9, those of ordinary skill in the art will appreciate that various embodiments may add, remove, reorder, or modify the depicted operations.

In GNN-based recommender systems, user/item embedding may be obtained by aggregating information from all neighbors. Popular items may overwhelm the long-tail items. A sub-modular selection module (e.g., sub-modular selection module 102) may select a set of diverse neighbors for aggregation. For example, the ground set for a user node u may consist of all of its neighbors Nᵤ. Facility location function (e.g., Equation 7 above) may be used to evaluate the diversity of a subset of items by first identifying the most similar item in the selected subset Sᵤ to every item i in the ground set (max_{i′∈S}_{ᵤ}sim(i, i′)∀i∈Nᵤ\Sᵤ). At 902, a diversity of the subset of neighbors may be evaluated. The diversity of the subset of neighbors may be evaluated by identifying a most similar item in the subset to every item in an entire set of neighbors. The similarity values may be summed. At 904, a sum of similarity values may be determined. A subset with a high function value may indicate that for every item in the ground set, there exists a similar item in the selected subset. For example, a subset with a high function value may indicate the selected subset is very diverse and representative of the ground set.

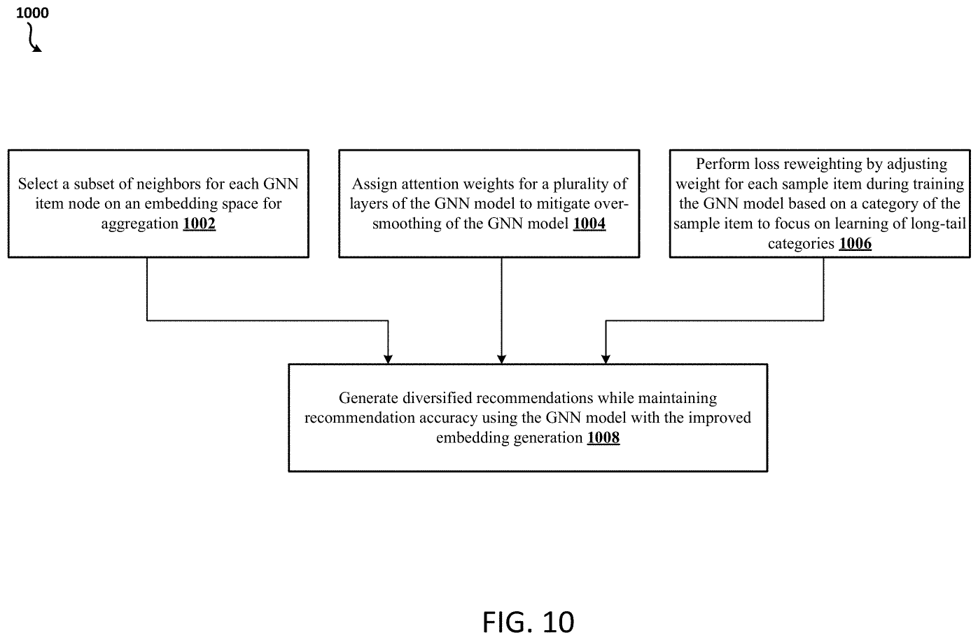

FIG. 10 illustrates an example process 1000 of improving embedding generation of a GNN model. For example, the system 100 may perform the process 1000. Although depicted as a sequence of operations in FIG. 10, those of ordinary skill in the art will appreciate that various embodiments may add, remove, reorder, or modify the depicted operations.

A sub-modular selection module (e.g., sub-modular selection module 102) may integrate submodular optimization into a GNN model (e.g., GNN model 108). The sub-modular selection module may be configured to determine (e.g., identify, find, select) a subset of diverse neighbors to aggregate for each GNN node. At 1002, a subset of neighbors may be selected for each GNN item node on an embedding space for aggregation. For example, the sub-modular selection module may select a set of diverse neighbors for aggregation. The diversified subset of neighbors may be determined, for example, by optimizing a submodular function. The subset of neighbors may comprise diverse items and may represent an entire set of neighbors of the GNN item node. Information aggregated from the diversified subset may help to uncover long-tail items and reflect them in the aggregated representation.

A layer attention module (e.g., layer attention module 104) may be configured to mitigate or eliminate the over-smoothing problem. The layer attention module may be configured to stabilize the training on deep GNN layers and may enable the recommender system to take advantage of high order connectivities for diversification. To stabilize the training on deep GNN layers and/or enable the system to take advantage of high order connectivities for diversification, the layer attention module may be configured to assign attention weights for each layer of the GNN model. At 1004, attention weights may be assigned for a plurality of layers of the GNN model. Assigning attention weights for the plurality of layers may mitigate over-smoothing of the GNN model.

A loss reweighting module (e.g., loss reweighting module 106) may be configured to reduces the weight given to popular items or categories. The loss reweighting module may be configured to focus on the learning of items belonging to long-tail (e.g., less popular) items or categories. At 1006, loss reweighting may be performed. Loss reweighting may be performed by adjusting weight for each sample item during training the GNN model. The weight for each sample may be adjusted based on a category of the sample item to focus on learning of long-tail categories. By focusing on the learning of items belonging to long-tail (e.g., less popular) items or categories, the loss reweighting module may assist the GNN model in focusing more on the long-tail items or categories and less on the popular items or categories.

Blending the sub-modular selection module, the layer attention module, and the loss reweighting module into the GNN model may lead to diversified recommendation while keeping the accuracy comparable to state-of-the-art GNN-based recommender systems. At 1008, diversified recommendations may be generated while maintaining recommendation accuracy using the GNN model with the improved embedding generation.

To evaluate the effectiveness of the recommender system 100, experiments were conducted on two real-world datasets with category information. The first dataset contains users' behavior on a consumer-to-consumer (C2C) retail platform. The first dataset contains multiple types of user behaviors, including clicking, purchasing, adding items to carts, and item favoring. These behaviors were all treated as positive samples. To ensure the quality of the first dataset, the 10-core setting was adopted (e.g., only users and items with at least 10 interactions were retained). The second dataset contains product review information and metadata from an online retailer. The 5-core version was adopted to ensure data quality of the second dataset. For both datasets, 60% was randomly split out for training, 20% was randomly split out for validation, and 20% was randomly split out for testing. Validation sets were used for hyperparameter tuning and early stopping.

To empirically evaluate and study the recommender system 100, the recommender system 100 was compared with representative recommender system baselines. The baselines that were selected include a Popularity Model. The Popularity Model is a non-personalized recommendation method that only recommends popular items to users. The baselines that were selected include a MF-BPR Model. The MF-BPR Model factorizes the interaction matrix into user and item latent factors. The baselines that were selected include a GCN Model. The GCN Model is one of the most widely used GNNs. The baselines that were selected include a LightGCN Model. The LightGCN Model is the state-of-the-art recommender system. The LightGCN Model is a GCN-based model but removes the transformation matrix, non-linear activation, and self-loop. The baselines that were selected include a DGCN Model. The DGCN Model is the current state-of-the-art diversified recommender system based on GNN, which bested several other popular methods.

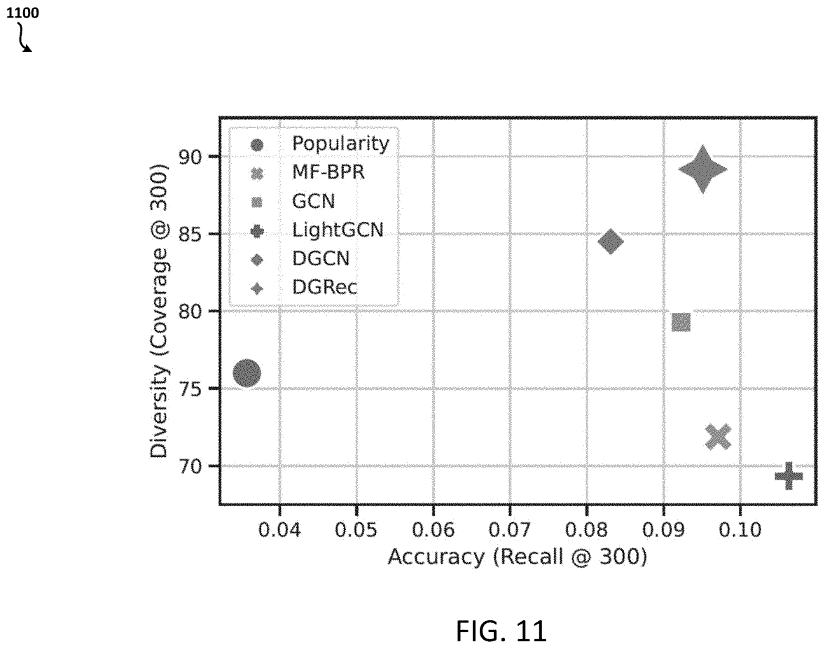

FIG. 11 shows an example graph 1100 illustrating the performance of the recommender system 100. The graph 1100 illustrate the accuracy-diversity trade-off associated with the recommender system 100 and the selected baselines described above. Accuracy and diversity were measured by Recall@300 and Coverage@300, respectively. The graph 1100 shows that the recommender system 100 (e.g., DGRec in the graph 1100) stands in the most upper-right position. This indicates that the recommender system 100 achieves the best trade-off between accuracy and diversity. Compared with the recommender system 100, the other baseline models with similar accuracy (GCN Model, MF-BPR Model) show an obvious drop in diversity. As compared with the LightGCN Model, the recommender system 100 greatly increases diversity with a small sacrifice on accuracy.

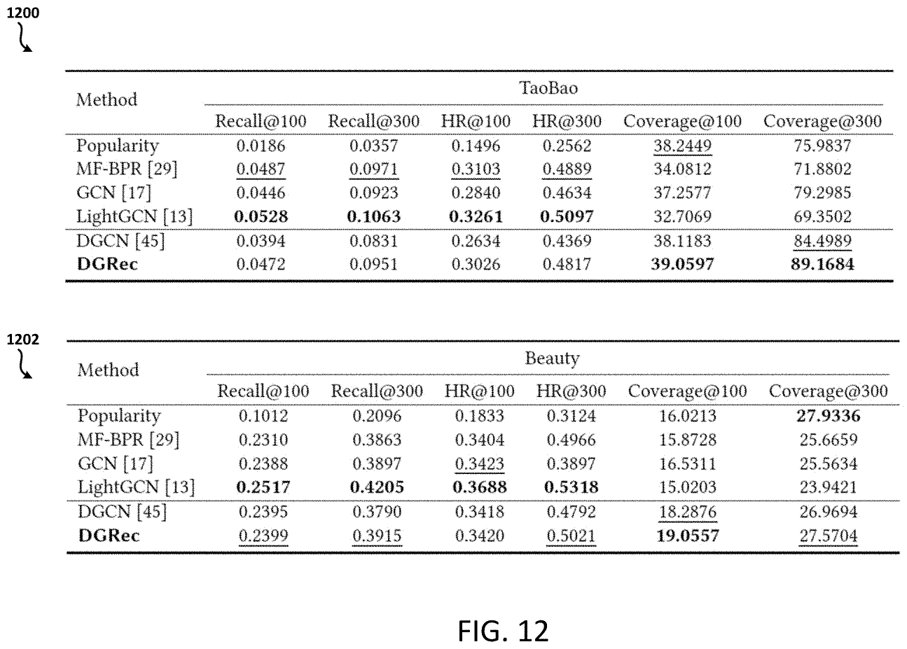

FIG. 12 shows example tables 1200 and 1202 illustrating the results of experiments conducted to empirically evaluate and study the recommender system 100. The table 1200 is associated with the first dataset. The best and second-best results shown in the table 1200 are in bold and underlined, respectively. The table 1202 is associated with the second dataset. The best and second-best results shown in the table 1202 are in bold and underlined, respectively. The results displayed in the table 1202 illustrate that the recommender system 100 achieves some of the best results on the second dataset. Thus, the table 1202 shows that the recommender system 100 is able to achieve the most diversified recommendation results.

The tables 1200 and 1202 indicates that, though the LightGCN Model always achieves the best Recall and Hit Ratio, its Coverage is always the lowest. Thus, the LightGCN Model cannot achieve an accuracy-diversity balance. While achieving the best Coverage, the recommender system 100 has similar results with the second best on Recall and Hit Ratio. Thus, the recommender system 100 increases the diversity with a small cost on the accuracy, which well balances the accuracy-diversity trade-off. The recommender system 100 surpasses the DGCN Model on all metrics. This indicates that the recommender system 100 surpasses the state of the art model, and the recommender system 100 is superior in terms of both accuracy and diversity.

In embodiments, different hyper-parameters influence the recommender system 100 in terms of the trade-off between accuracy/diversity. The layer number may be an influential hyperparameter in the recommender system 100. The layer number may indicate the number of GNN layers stacked to generate the user/item embedding. The layer attention described herein was compared with the mean aggregation on both accuracy and diversity.

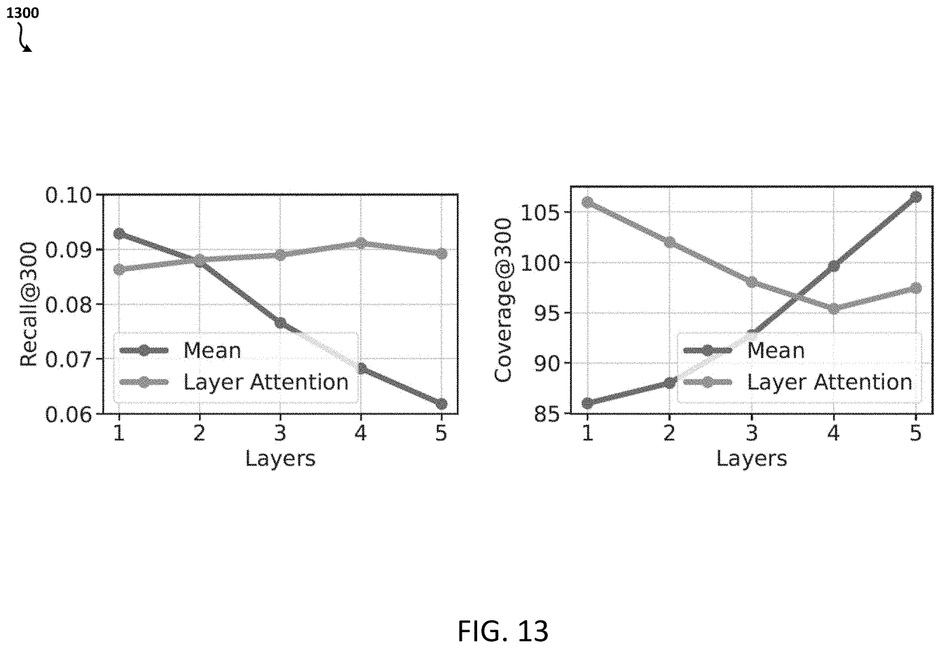

FIG. 13 shows an example set of graphs 1300. The set of graphs 1300 illustrate the experimental results of comparing the layer attention described herein with the mean aggregation on both accuracy and diversity. The set of graphs 1300 indicates that, with the mean aggregation, Recall@300 drops quickly with the increase of layers. This reflects the well-known over-smoothing problem in GNN. The increase in Coverage@300 verifies a hypothesis that a diverse embedding representation may be obtained by adding more information from higher-order connections. However, mean aggregation does not make an effective trade-off between accuracy and diversity. The sharp drop on Recall@300 renders the increased diversity meaningless. With the proposed layer attention, the recommender system 100 does not suffer from the over-smoothing problem and achieves gradually increased Recall@300 with the increase of layers. This indicates that layer attention can effectively learn different attention weights for each layer to fit the data. At the same time, the set of graphs 1300 indicate that the recommender system 100 generally achieves a high Coverage@300. This indicates that the layer attention module can retain a good performance on diversity with a different number of layers. As shown in the set of graphs 1300, when mean aggregation and layer attention achieve similar Recall@300 (2 layers), Coverage@300 of layer attention is much larger than mean aggregation. The case is similar if we compare Recall@300 when they achieve similar Coverage@300. This indicates that the layer attention used in the recommender system 100 can achieve a much better accuracy diversity trade-off than mean aggregation.

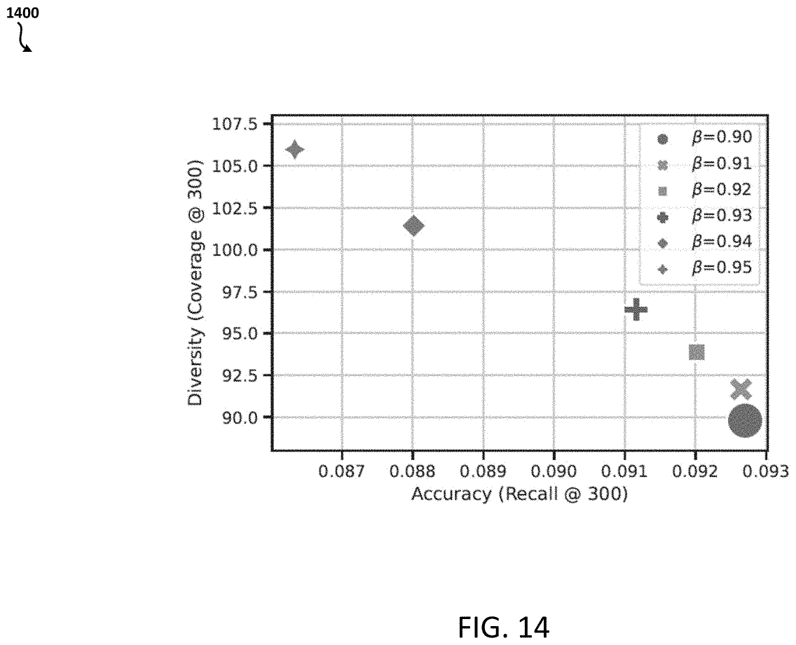

As described above with regard to FIG. 4, β is the hyper-parameter that decides the weight. A larger β may further decrease the weight of popular categories. Thus, β may control the weight on loss calculated on each sample. With a larger β, the recommender system 100 would concentrate more on the items that belong to long-tail categories. FIG. 14 shows an example graph 1400 illustrating an accuracy-diversity trade-off diagram. The graph 1400 shows that, with the increase of β, accuracy gradually drops, and diversity increases. This may indicate that focusing on the training of long-tail categories can greatly increase diversity. The graph 1400 shows that the accuracy drops slowly with the increase in diversity. When β=0.95, the recommender system 100 achieves a Coverage@300 of more than 105 and Recall@300 of more than 0.086. Experimental results show that by focusing on the training of items belonging to the long-tail categories, β can be used effectively to balance between diversity and accuracy.

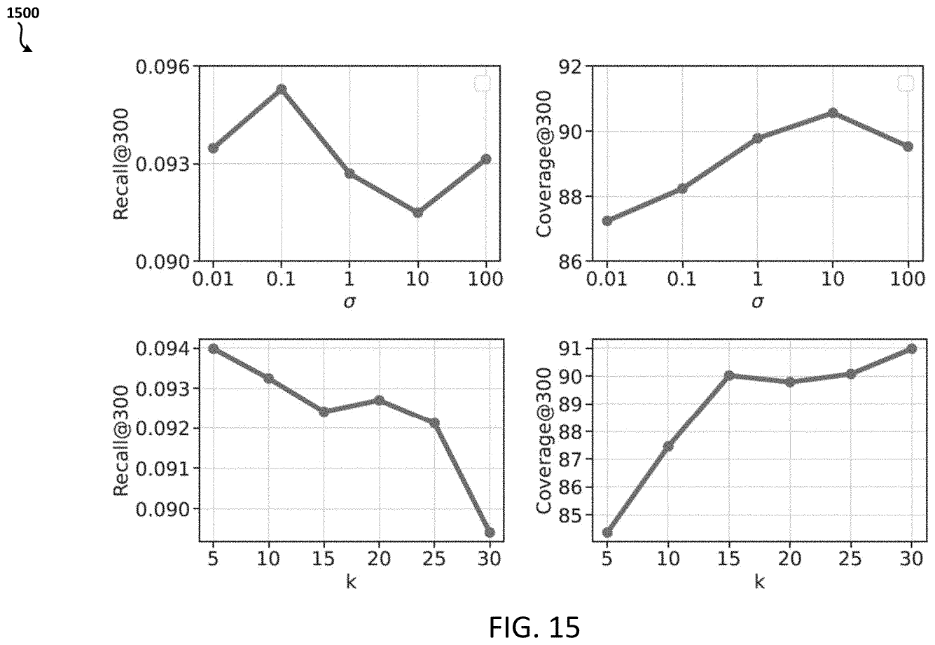

As described above with regard to FIG. 2, the hyper-parameter k is the budget for neighbor selection, and the hyper-parameter σ is used to compute the pair-wise similarity of neighbors. FIG. 15 shows an example set of graphs 1500. The set of graphs 1500 illustrates experimental results associated with the hyper-parameters k and σ. The set of graphs 1500 show that the recommender system 100 is not that sensitive to σ. The recommender system 100 has a stable good performance on both Recall@300 and Coverage@300 when σ varies from 0.01 to 100. With different values for σ, the set of graphs 1500 show the trade-off between accuracy/diversity. When Coverage@300 achieves the best at 10, Recall@300 is the worst. k is the number of neighbors for GNN aggregation. Neighbors are selected by submodular function to maximize diversity. As we can see from the set of graphs 1500, Recall@300 gradually decreases, and Coverage@300 increases with the increase of k. Submodular neighbor selection selects a diversified subset of neighbors. With a larger set, the recommender system 100 can aggregate from more diversified neighbors, which would lead to an increase in diversity. At the same time, accuracy would drop as a trade-off. We can also observe that Recall@300 does not drop much with the increase in diversity. Experiments on σ and k show the recommender system 100 is not sensitive to the submodular selection model and would not have a dramatic change because of the submodular selection model. Meanwhile, the submodular selection model may also balance accuracy and diversity by σ and k.

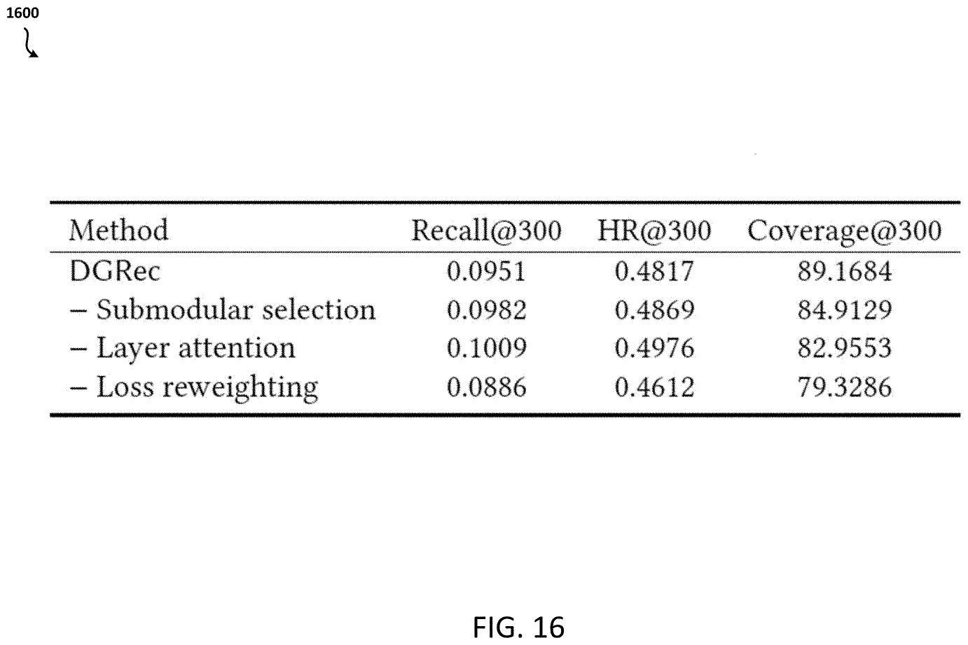

An ablation study was performed on the first dataset by removing each of the three models (submodular selection model 102, layer attention module 104, and loss reweighting module 106). FIG. 16 shows a table 1600 illustrating the experiment results of the ablation study. The table 1600 indicates that the intact recommender system 100 achieves the best Coverage@300. The combination of the submodular selection model 102, layer attention module 104, and loss reweighting module 106 can effectively increase diversity.

The table 1600 indicates that the intact recommender system 100 achieves comparable results with the best methods on Recall@300 and HR@300. The table 1600 indicates that shows the recommender system 100 can well trade-off between accuracy and diversity with all three of the submodular selection model 102, the layer attention module 104, and loss reweighting module 106. If the submodular selection model 102 is removed, Coverage@300 drops from 89.1684 to 84.9129 while there is only a tiny difference on Recall@300 and HR@300. This indicates that the submodular selection model 102 can increase the diversity with minimal cost on accuracy. If the layer attention module 104 is removed, Coverage@300 decreases with the increase on Recall@300 and HR@300. This indicates that the layer attention module 104 balances accuracy and diversity. If the loss reweighting module 106 is removed, Recall@300, HR@300, and Coverage@300 all drop greatly. The loss reweighting module 104 thus has the largest impact on the recommender system 100, because it not only balances the training on long-tail categories but also guides the learning of layer attention.

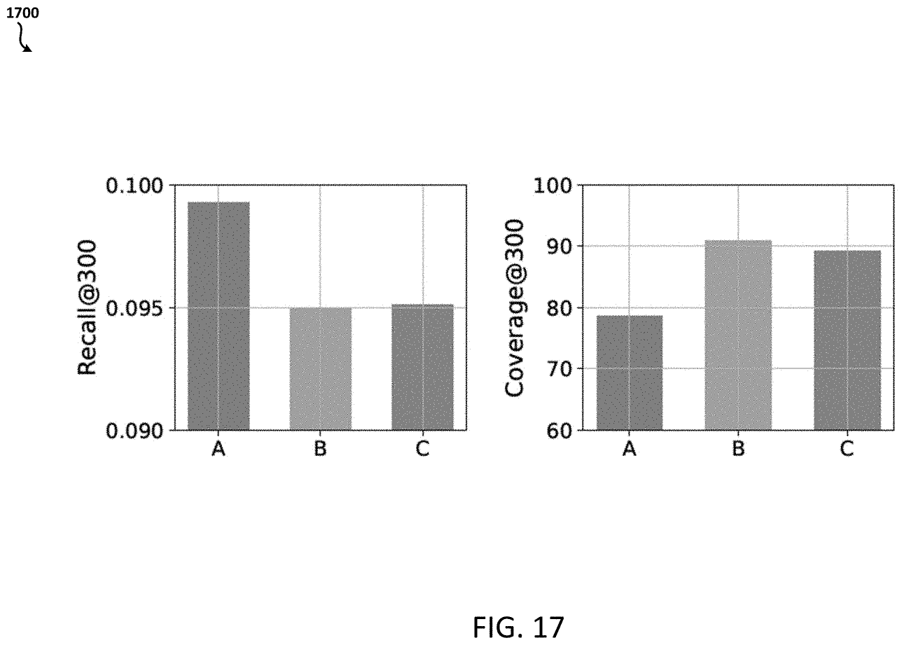

The influence of different submodular functions on model performance was determined. Two commonly used submodular functions were used to replace the facility location function (e.g., Equation 7). FIG. 17 shows a set of charts 1700. The set of charts 1700 illustrate the experimental results of replacing the facility location function with the two commonly used submodular functions. Model A utilizes bucket coverage submodular function. Before selection, Model A clusters on each dimension and divides each dimension into buckets. The submodular function counts the gain on covered buckets. Model B utilizes category coverage submodular function. This function counts the gain on covered categories. Model C is the recommender system 100, which utilizes the facility location function. Among the three models, Model A and Model C do not need item category information. They directly select neighbors based on neighbor embedding. Model B needs item category information to be able to compute category coverage gain during each selection.

The set of charts 1700 show that compared with the other two models, Model A has much higher performance on Recall@300 and much lower performance on Coverage@300. The set of charts 1700 show that the selection of submodular functions has an influential impact on performance. Model B and Model C achieve similar results with respect to Recall@300 and Coverage@300. This indicates the embedding learned by Model C may accurately capture the category information, and the facility location function enlarges the category coverage during neighbor selection. The facility location function is utilized in the recommender system 100 for two reasons. Firstly, it can nearly achieve the best diversity compared with other methods. Secondly, it does not need category information during aggregation, which can enlarge the application scenarios when the category information is unobserved.

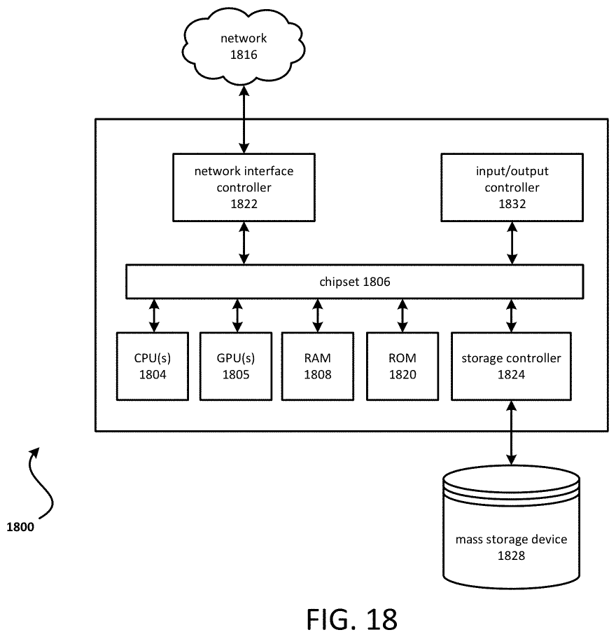

FIG. 18 illustrates a computing device that may be used in various aspects, such as the services, networks, modules, and/or devices depicted in FIG. 1. With regard to the example architecture of FIG. 1, the cloud network (and any of its components), the client devices, and/or the network may each be implemented by one or more instance of a computing device 1800 of FIG. 18. The computer architecture shown in FIG. 18 shows a conventional server computer, workstation, desktop computer, laptop, tablet, network appliance, PDA, e-reader, digital cellular phone, or other computing node, and may be utilized to execute any aspects of the computers described herein, such as to implement the methods described herein.

The computing device 1800 may include a baseboard, or “motherboard,” which is a printed circuit board to which a multitude of components or devices may be connected by way of a system bus or other electrical communication paths. One or more central processing units (CPUs) 1804 may operate in conjunction with a chipset 1806. The CPU(s) 1804 may be standard programmable processors that perform arithmetic and logical operations necessary for the operation of the computing device 1800.

The CPU(s) 1804 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 1804 may be augmented with or replaced by other processing units, such as GPU(s) 1805. The GPU(s) 1805 may comprise processing units specialized for but not necessarily limited to highly parallel computations, such as graphics and other visualization-related processing.

A chipset 1806 may provide an interface between the CPU(s) 1804 and the remainder of the components and devices on the baseboard. The chipset 1806 may provide an interface to a random-access memory (RAM) 1808 used as the main memory in the computing device 1800. The chipset 1806 may further provide an interface to a computer-readable storage medium, such as a read-only memory (ROM) 1820 or non-volatile RAM (NVRAM) (not shown), for storing basic routines that may help to start up the computing device 1800 and to transfer information between the various components and devices. ROM 1820 or NVRAM may also store other software components necessary for the operation of the computing device 1800 in accordance with the aspects described herein.

The computing device 1800 may operate in a networked environment using logical connections to remote computing nodes and computer systems through local area network (LAN). The chipset 1806 may include functionality for providing network connectivity through a network interface controller (NIC) 1822, such as a gigabit Ethernet adapter. A NIC 1822 may be capable of connecting the computing device 1800 to other computing nodes over a network 1816. It should be appreciated that multiple NICs 1822 may be present in the computing device 1800, connecting the computing device to other types of networks and remote computer systems.

The computing device 1800 may be connected to a mass storage device 1828 that provides non-volatile storage for the computer. The mass storage device 1828 may store system programs, application programs, other program modules, and data, which have been described in greater detail herein. The mass storage device 1828 may be connected to the computing device 1800 through a storage controller 1824 connected to the chipset 1806. The mass storage device 1828 may consist of one or more physical storage units. The mass storage device 1828 may comprise a management component. A storage controller 1824 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1800 may store data on the mass storage device 1828 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 1828 is characterized as primary or secondary storage and the like.

For example, the computing device 1800 may store information to the mass storage device 1828 by issuing instructions through a storage controller 1824 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1800 may further read information from the mass storage device 1828 by detecting the physical states or characteristics of one or more particular locations within the physical storage units.

In addition to the mass storage device 1828 described above, the computing device 1800 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 1800.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 1828 depicted in FIG. 18, may store an operating system utilized to control the operation of the computing device 1800. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 1828 may store other system or application programs and data utilized by the computing device 1800.

The mass storage device 1828 or other computer-readable storage media may also be encoded with computer-executable instructions, which, when loaded into the computing device 1800, transforms the computing device from a general-purpose computing system into a special-purpose computer capable of implementing the aspects described herein. These computer-executable instructions transform the computing device 1800 by specifying how the CPU(s) 1804 transition between states, as described above. The computing device 1800 may have access to computer-readable storage media storing computer-executable instructions, which, when executed by the computing device 1800, may perform the methods described herein.

A computing device, such as the computing device 1800 depicted in FIG. 18, may also include an input/output controller 1832 for receiving and processing input from a number of input devices, such as a keyboard, a mouse, a touchpad, a touch screen, an electronic stylus, or other type of input device. Similarly, an input/output controller 1832 may provide output to a display, such as a computer monitor, a flat-panel display, a digital projector, a printer, a plotter, or other type of output device. It will be appreciated that the computing device 1800 may not include all of the components shown in FIG. 18, may include other components that are not explicitly shown in FIG. 18, or may utilize an architecture completely different than that shown in FIG. 18.

As described herein, a computing device may be a physical computing device, such as the computing device 1800 of FIG. 18. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method for diversifying recommendations by improving embedding generation of a Graph Neural Network (GNN) model, comprising:
selecting a subset of neighbors for each GNN item node on an embedding space for aggregation, wherein the subset of neighbors comprises diverse items and represents an entire set of neighbors of the GNN item node;
assigning attention weights for a plurality of layers of the GNN model to mitigate over-smoothing of the GNN model; and
performing loss reweighting by adjusting weight for each sample item during training the GNN model based on a category of the sample item to focus on learning of long-tail categories.

2. The method of claim 1, further comprising:
selecting the subset of neighbors by maximizing a submodular function.

3. The method of claim 2, further comprising:
approximating a maximum of the submodular function using a greedy algorithm, wherein the approximating a maximum of the submodular function using a greedy algorithm further comprises:
adding an item with a largest marginal gain to the subset of neighbors every step of a greedy neighbor selection; and
performing a predetermined number of steps of the greedy neighbor selection to obtain the subset of neighbors, wherein the subset of neighbors is constrained to have items no greater than the predetermined number.

4. The method of claim 2, further comprising:
evaluating a diversity of the subset of neighbors by identifying a most similar item in the subset to every item in the entire set of neighbors and determining a sum of similarity values.

5. The method of claim 4, wherein the evaluating a diversity of the subset of neighbors is performed based on a facility location function defined as:
$$f ( {S}_{u} ) = {\sum }_{i ∈ {N}_{u} \backslash {S}_{u}} {max}_{{i}^{′} ∈ {N}_{u} ∖ {S}_{u}} s i m ( i , {i}^{′} ) ,$$
wherein Sᵤ represents a subset of neighbors associated with a GNN item node u, Nᵤ represents an entire set of neighbors of the GNN item node u, and sim (i, i′) represents a similarity between a most similar item i′ in the subset of neighbors to every item i in an entire set of neighbors of the GNN item node.

6. The method of claim 1, further comprising:
learning the attention weights for the plurality of layers of the GNN model by an attention mechanism to optimize a loss function.

7. The method of claim 1, wherein the performing loss reweighting by adjusting weight for each sample item during training the GNN model based on a category of the sample item further comprises:
increasing weights for sample items belonging to the long-tail categories.

8. The method of claim 1, further comprising:
generating diversified recommendations while maintaining recommendation accuracy using the GNN model with the improved embedding generation.

9. A system, comprising:
at least one processor; and
at least one memory comprising computer-readable instructions that upon execution by the at least one processor cause the system to perform operations comprising:
selecting a subset of neighbors for each GNN item node on an embedding space for aggregation, wherein the subset of neighbors comprises diverse items and represents an entire set of neighbors of the GNN item node;
assigning attention weights for a plurality of layers of the GNN model to mitigate over-smoothing of the GNN model; and
performing loss reweighting by adjusting weight for each sample item during training the GNN model based on a category of the sample item to focus on learning of long-tail categories.

10. The system of claim 9, the operations further comprising:
selecting the subset of neighbors by maximizing a submodular function.

11. The system of claim 10, the operations further comprising:
approximating a maximum of the submodular function using a greedy algorithm, wherein the approximating a maximum of the submodular function using a greedy algorithm further comprises:
adding an item with a largest marginal gain to the subset of neighbors every step of a greedy neighbor selection; and
performing a predetermined number of steps of the greedy neighbor selection to obtain the subset of neighbors, wherein the subset of neighbors is constrained to have items no greater than the predetermined number.

12. The system of claim 10, the operations further comprising:
evaluating a diversity of the subset of neighbors by identifying a most similar item in the subset to every item in the entire set of neighbors and determining a sum of similarity values.

13. The system of claim 9, the operations further comprising:
learning the attention weights for the plurality of layers of the GNN model by an attention mechanism to optimize a loss function.

14. The system of claim 9, wherein the performing loss reweighting by adjusting weight for each sample item during training the GNN model based on a category of the sample item further comprises:
increasing weights for sample items belonging to the long-tail categories.

15. A non-transitory computer-readable storage medium, storing computer-readable instructions that upon execution by a processor cause the processor to implement operations, the operation comprising:
selecting a subset of neighbors for each GNN item node on an embedding space for aggregation, wherein the subset of neighbors comprises diverse items and represents an entire set of neighbors of the GNN item node;
assigning attention weights for a plurality of layers of the GNN model to mitigate over-smoothing of the GNN model; and
performing loss reweighting by adjusting weight for each sample item during training the GNN model based on a category of the sample item to focus on learning of long-tail categories.

16. The non-transitory computer-readable storage medium of claim 15, the operations further comprising:
selecting the subset of neighbors by maximizing a submodular function.

17. The non-transitory computer-readable storage medium of claim 16, the operations further comprising:
approximating a maximum of the submodular function using a greedy algorithm, wherein the approximating a maximum of the submodular function using a greedy algorithm further comprises:
adding an item with a largest marginal gain to the subset of neighbors every step of a greedy neighbor selection; and
performing a predetermined number of steps of the greedy neighbor selection to obtain the subset of neighbors, wherein the subset of neighbors is constrained to have items no greater than the predetermined number.

18. The non-transitory computer-readable storage medium of claim 16, the operations further comprising:
evaluating a diversity of the subset of neighbors by identifying a most similar item in the subset to every item in the entire set of neighbors and determining a sum of similarity values.

19. The non-transitory computer-readable storage medium of claim 15, the operations further comprising:
learning the attention weights for the plurality of layers of the GNN model by an attention mechanism to optimize a loss function.

20. The non-transitory computer-readable storage medium of claim 15, wherein the performing loss reweighting by adjusting weight for each sample item during training the GNN model based on a category of the sample item further comprises:
increasing weights for sample items belonging to the long-tail categories.
